(19) United States
(12) Patent Application Publication
(10) Pub. No.: US 2011/0111516 A1
(43) Pub. Date: May 12, 2011

(54) SURFACE ACOUSTIC WAVE SENSOR SYSTEM FOR USING OSCILLATION METHOD AND SENSING METHOD USING THE SAME

(75) Inventors: Hun Joo LEE, Hwaseong-si (KR); Soo Suk LEE, Suwon-si (KR); Yeul ho LEE, Seoul (KR)

(73) Assignee: SAMSUNG ELECTRONICS CO., LTD., Suwon-si (KR)

(21) Appl. No.: 12/775,004

(22) Filed: May 6, 2010

(30) Foreign Application Priority Data
Nov. 6, 2009 (KR) 10-2009-0106934

(51) Int. Cl. G01N 27/00

(52) U.S. Cl. 436/149; 422/82.01

(57) ABSTRACT

Provided is a surface acoustic wave sensor system, in which multiplexers are connected to input and output terminals of a plurality of surface acoustic wave devices through one feedback loop, and thus one oscillation channel is configured. Such a surface acoustic wave sensor system can prevent errors caused by deviations between oscillators, and thus sensitivity and reproducibility can be improved.

### CROSS-REFERENCE TO RELATED APPLICATION

This application claims priority to Korean Patent Application No. 10-2009-0106934, filed on Nov. 6, 2009, and all the benefits accruing therefrom under 35 U.S.C. §119, the content of which in its entirety is hereby incorporated by reference.

### BACKGROUND

1) Field

The general inventive concept relates to a surface acoustic wave (“SAW”) sensor system, and more particularly, to a SAW sensor system for using an oscillation method, and a method for sensing a target material using the same.

2) Description of the Related Art

A surface acoustic wave (“SAW”) is a mechanical wave (in contrast to an electrical wave) that is generated from movement of particles due to external thermal, mechanical and/or electrical forces. In a SAW, a large proportion of vibrational energy is concentrated on a surface of a medium. A SAW sensor is a device that senses a specific material present in a gas using a SAW, or senses a target material present in a solution, similar to a biosensor.

Generally, the SAW sensor is disposed on a substrate made of a piezoelectric material, and includes a receptor that binds to a target material on a surface of the SAW sensor. Thus, when a sample containing the target material flows to the SAW sensor, a wavelength is changed due to a physical, chemical and/or electrical reaction between the target material and the receptor. The resulting change is used to determine and/or monitor the content of the target material.

For a biosensor, when a biomolecule, such as a protein, antibody, antigen, deoxyribonucleic acid (“DNA”), ribonucleic acid (“RNA”), bacteria, an animal cell, a virus or tissue, and a toxin generated therefrom, specifically binds to a surface of the biosensor, a surface mass of the sensor changes, and thereby a signal drift occurs in the sensor. As a result, the biosensor can determine and/or monitor the content of the target material.

Methods for monitoring the change of a wavelength in the SAW sensor are generally divided into two types. A first type is an oscillation method of checking the change of the wavelength in the SAW device by re-applying an output signal emitted from the SAW device to the SAW device as an input signal. A second type of method for monitoring the change of the wavelength in the SAW sensor is measuring the change of the wavelength by applying a specific frequency, generated outside the SAW sensor, to an input inter-digital transducer (“IDT”) electrode of the SAW device and plotting output signals according to frequencies. Generally, it has been shown that the oscillation method provides greater and more stable drifts of the signal according to the change of the SAW than the oscillation method, and the sensor using the oscillation method therefore typically has improved sensitivity relative to that of the oscillation method.

### SUMMARY

The general inventive concept includes a surface acoustic wave (“SAW”) sensor system using an oscillation method, in which signals are selectively applied to a plurality of SAW devices using one oscillation channel to oscillate the SAW devices, and a detector of one channel senses a signal drift generated in the device.

Provided is a SAW sensor system, which includes: SAW devices; a first multiplexer connected to input terminals of the SAW devices; a second multiplexer connected to output terminals of the SAW devices; a feedback loop circuit connected between the first multiplexer and the second multiplexer; a channel controller including a first port, connected to the first multiplexer, and a second port, connected to the second multiplexer, and which applies a channel selection signal to at least one of the first multiplexer and the second multiplexer; and a detector connected to the feedback loop circuit and which senses an electrical signal from the second multiplexer.

The channel controller may apply the channel selection signal to the first multiplexer and the second multiplexer through the first port and the second port, respectively.

The feedback loop circuit may selectively transmit electrical oscillation signals to the surface acoustic wave devices through the first multiplexer and electrical signals generated from the surface acoustic wave devices to the first multiplexer through the second multiplexer.

The system may further include capacitors connected between the input terminals of the surface acoustic wave devices and the first multiplexer, and between the output terminals of the surface acoustic wave devices and the second multiplexer.

The feedback loop circuit may include an amplifier which amplifies the electrical signal from the second multiplexer.

The feedback loop circuit may further include an attenuator connected between the second multiplexer and the amplifier.

The feedback loop circuit may further include a low-pass filter connected between the amplifier and the first multiplexer.

The channel controller and the detector may be implemented in one integrated circuit.

The SAW devices may be disposed on a single base plate.

Each of the SAW devices may include a pair of inter-digital transducer electrodes disposed on a piezoelectric substrate, and a receptor disposed on the piezoelectric substrate to cover at least a portion of the corresponding pair of inter-digital transducer electrodes. A target material may be bound to the receptor.

Also provided is a method for sensing a target material using the SAW sensor.

The method includes: selecting at least one of the surface acoustic wave devices and inputting channel selection signals from the channel controller to the first multiplexer and the second multiplexer; inputting a reference frequency to the input terminal of the surface acoustic wave device selected by the first multiplexer; transmitting an output frequency from an output terminal of the selected surface acoustic wave device to the feedback loop circuit through the second multiplexer; comparing the output frequency transmitted to the feedback loop circuit with the reference frequency; and sensing a change with the detector to sense a target material.

The reference frequency is a frequency when the target material is not present.

The sample may be a biological sample.

### BRIEF DESCRIPTION OF THE DRAWINGS

The above and other aspects of the general inventive concept will become more readily apparent by describing in further detail example embodiments thereof with reference to the accompanying drawings, in which:

FIG. 1 is a plan view of an example embodiment of a unit surface acoustic wave (“SAW”) device of a SAW sensor system;

FIG. 2 is a schematic circuit diagram of an example embodiment of a SAW sensor system;

FIG. 3 a schematic circuit diagram of a conventianal SAW sensor system;

FIGS. 4 to 5 are graphs of frequency versus time showing frequency stabilities of comparative and experimental example embodiments of SAW sensors.

FIGS. 6 to 7 are graphs of frequency versus time showing frequency changes of experimental and comparative example embodiments of SAW sensors.

### DETAILED DESCRIPTION

The general inventive concept now will be described more fully hereinafter with reference to the accompanying drawings, in which various example embodiments are shown. This invention may, however, be embodied in many different forms, and should not be construed as limited to the example embodiments set forth herein. Rather, these example embodiments are provided so that this disclosure will be thorough and complete, and will fully convey the scope of the general inventive concept to those of ordinary skill in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein but are to include deviations in shapes that result, for example, from manufacturing. For example, a region illustrated or described as flat may, typically, have rough and/or nonlinear portions. Moreover, sharp angles that are illustrated may be rounded. Thus, the regions illustrated in the figures are schematic in nature and their shapes are not intended to illustrate the precise shape of a region and are not intended to limit the scope of the present claims.

The following terms, as used herein, will be defined as follows.

The term “multiplexer” refers to a multi-port frequency dependant device that can be used as a separator and/or a combiner of signals, and includes any device capable of functioning as a multiplexer, a demultiplexer, or both the multiplexer and the demultiplexer.

The term “target material” refers to a subject material to be sensed, e.g., a molecule to be recognized by a receptor in a surface acoustic wave (“SAW”) device. In one or more example embodiments, the receptor may specifically bind to a target material, such as in the binding of an antibody to an antigen.

The term “biological sample” refers to any material capable of containing a target material. The biological sample may be, but is not limited to, blood or any component thereof (plasma or serum, for example), menstrual fluid, mucus, sweat, tears, urine, feces, saliva, sputum, semen, cerebrospinal fluid, genital secretions, gastric lavage fluid, pericardial or abdominal fluid or lavage fluid, a throat swab, pleural lavage fluid, ear wax, hair, skin cells, nails, mucosae, aqua amnii, leukorrhea or any bodily liquid, spinal fluid, a gaseous sample containing breath or body smell of a human, flatulence or other gas, any biological tissue or material, or an extract or suspension thereof.

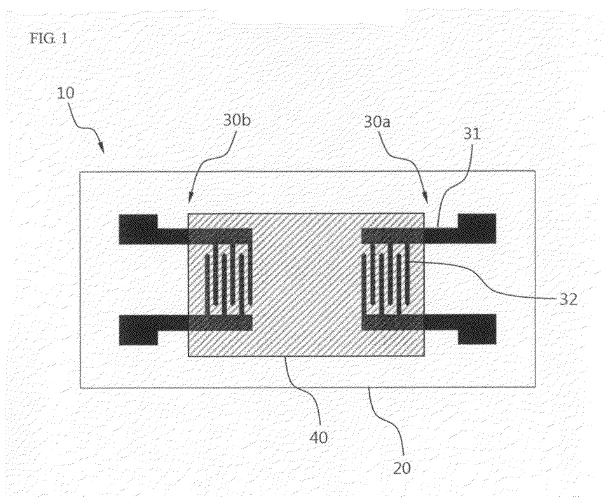

A unit SAW device used in a SAW sensor system will now be described in further detail with reference to FIG. 1. FIG. 1 is a plan view a unit SAW device of a SAW sensor system.

A SAW device 10 includes a piezoelectric substrate 20 and inter-digital transducer (“IDT”) electrodes 30a and 30b, which in one or more example exemplary embodiments are disposed as a pair on the piezoelectric substrate 20. The piezoelectric substrate 20 is formed of a material having electrical characteristics that change when a mechanical signal is applied (e.g., a piezoelectric effect), and/or which generate a mechanical signal when an electrical signal is applied (e.g., an inverse piezoelectric effect). Specifically, for example, the material of the piezoelectric substrate 20 may include, but is not limited to, lithium niobate (LiNbO₃), lithium tantalite (LiTaO₃), lithium tetraborate (Li₂B₄O₇), barium titanate (BaTiO₃), lead zirconate (PbZrO₃), lead titanate (PbTiO₃), lead zirconate titanate (“PZT”), zinc oxide (ZnO), gallium arsenide (GaAs), quartz or niobate.

One IDT electrode 30a of the pair of IDT electrodes 30a and 30b generates a surface acoustic wave based on an applied signal, and is referred to as an “input IDT” or a “transmitter.” The generated surface acoustic wave is transmitted to the other IDT electrode 30b along a surface of the piezoelectric substrate 20 while being expanded and compressed at a predetermined frequency, and is thus converted into an electrical signal by the inverse piezoelectric effect. The other IDT electrode 30b is referred to as an “output IDT” or a “receiver.”

Each of IDT electrodes 30a and 30b includes a bar-type electrode 31 and a finger electrode 32 extending from the bar-type electrode 31 in a comb shape. Put another way, the finger electrodes 32 are interdigitated, as shown in FIG. 1. The IDT electrodes 30a and 30b include a metallic thin film metal, such as aluminum (Al), an aluminum alloy, a copper (Cu) alloy or gold (Au). The IDT electrodes 30a and 30b may have an artificial or natural oxide film (not shown), and a hydrophobic film (not shown) formed on a surface of the oxide film.

As shown in FIG. 1, the SAW device 10 may further include a receptor 40. The receptor 40 may be disposed to cover at least a portion of the IDT electrodes 30a and 30b on the piezoelectric substrate 20, and may bind to a specific target material.

In an example embodiment, a mechanical wave is generated by applying an electrical signal to the input IDT electrode 30a, and the mechanical wave is changed by a mechanical, chemical and/or electrical reaction caused by the specific binding of the target material to the receptor 40. Thus, the binding of the target material is sensed by observing a signal drift caused by changes in center frequency, phase and size of the signal generated from at the output IDT electrode 30b, and the target material is thereby qualitatively and quantitatively sensed, detected, analyzed and/or monitored.

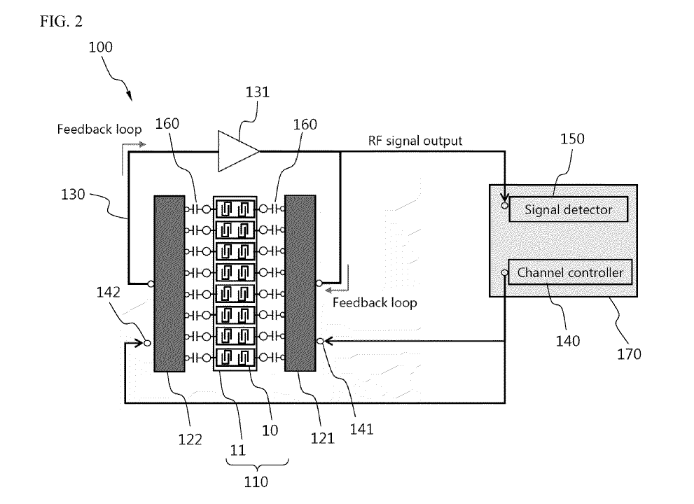

A SAW sensor system including the unit SAW devices in an array structure will now be described in further detail with reference to FIG. 2. FIG. 2 is a schematic circuit diagram of example embodiment of a SAW sensor system.

A SAW sensor system 100 includes a SAW device array 110 including a plurality of unit SAW devices 10 and single base plate 11. For example, eight of the unit SAW devices 10 shown in FIG. 1 may constitute the SAW device array 110 of FIG. 2, but alternative exemplary embodiments are not limited thereto.

The SAW sensor system 100 includes a first multiplexer 121 and a second multiplexer 122. The first multiplexer 121 and the second multiplexer 122 are connected to input and output terminals, respectively, of the SAW device array 110. The first multiplexer 121 is connected to an input terminal of the SAW device array 110, and the second multiplexer 122 is connected to an output terminal of the SAW device array 110.

The SAW sensor system 100 further includes a feedback loop circuit 130 connected between the first multiplexer 121 and the second multiplexer 122. The feedback loop circuit 130 transmits an electrical oscillation signal to the SAW device array 110 through the first multiplexer 121, and transmits an electrical signal generated from the SAW device array 110 and transmitted through the second multiplexer 122 to the first multiplexer 121. The SAW device array 110, the first multiplexer 121, the second multiplexer 122 and the feedback loop circuit 130 are included in one oscillation channel. However, when a plurality of oscillation channels corresponding to a plurality of SAW devices, are formed and connected to a detector, errors may be made by deviations between the SAW devices, between oscillators, and between detector channels. The deviations between the oscillators may generate deviation between frequencies, even when no reaction takes place on each SAW device, thereby generating error data. Accordingly, the SAW sensor may have serious errors in sensitivity and reproducibility, resulting in serious problems of reliability of the sensor.

However, according to the example embodiments described herein, the SAW device array 110 in which the plurality of SAW devices are integrated may be connected to the feedback loop circuit 130 through the first multiplexer 121 and the second multiplexer 122, thereby substantially reducing and/or effectively preventing any deviation between the oscillators.

Still referring to FIG. 2, the feedback loop circuit 130 may include an amplifier 131 for amplifying an electrical signal transmitted through the second multiplexer 122. The feedback loop circuit 130 may further include an attenuator (not shown) connected between the second multiplexer 122 and the amplifier 131, and a low-pass filter (not shown) connected between the amplifier 131 and the first multiplexer 121.

The SAW sensor system 100 further includes a channel controller 140 and a detector 150, which, in one or more example embodiments is a signal detector 150, as shown in FIG. 2. The channel controller 140 and the detector 150 may be implemented in one integrated circuit (“IC”) 170. The channel controller 140 is connected to the first multiplexer 121 through a first port 141, and is connected to the second multiplexer 122 through a second port 142, and thus applies the same channel selection signal to the first multiplexer 121 and the second multiplexer 122 through the first port 141 and the second port 142, respectively. Therefore, a desired one of the SAW devices of the SAW device array 110 may be selected.

Since the detector 150 is connected to the feedback loop circuit 130, the detector 150 senses signals generated from the SAW devices and which are transmitted through the second multiplexer 122. When channels are sequentially altered by providing signals to the first multiplexer 121 and the second multiplexer 122, the channel controller 140 determines an address of a signal value output from the SAW device, and stores the signal of each channel without changing signals between the SAW devices. In one or more example embodiments, the detector 150 and the channel controller 140 may be configured in separate chips, not in one integrated circuit 170.

In at least one example embodiment, the SAW sensor system 100 may further include a plurality of capacitors 160. More particularly, capacitors 160 of the plurality of capacitors 160 may be connected between the input terminal of the SAW device array 110 and the first multiplexer 121, as well as between the output terminal of the SAW device array 110 and the second multiplexer 122, as shown in FIG. 2. To operate the first multiplexer 121 and the second multiplexer 122, a current signal may be applied thereto. Thus, when a sample containing the target material is a solution-type sample, the solution may be electrolyzed on the IDT electrode in the SAW device array 110. As a result, when the capacitors 160 are disposed between the SAW device array 110 and the first multiplexer 121, and between the SAW device array 110 and the second multiplexer 122, direct current (“DC”) does not flow in the SAW device array 110 when the first multiplexer 121 and/or the second multiplexer 122 are operating.

As described herein, the SAW sensor system 100 may sense a plurality of target materials at one time using the SAW device array 110 including the plurality of SAW devices 10. In addition, only one oscillation channel and the detector 150 are connected to the SAW device array 110 using the first multiplexer 121 and the second multiplexer 122, therefore errors caused by deviations between oscillation channels and between channels of the detector 150 are effectively prevented, and thus the sensitivity and reproducibility of the system are substantially improved. Moreover, the SAW sensor system 100 uses an amplification method using the feedback loop circuit 130, resulting in a further increase in sensitivity.

An example embodiment of a method for sensing a target material from a sample using a SAW sensor system will now be described in further detail.

In an example embodiment, the sensing method includes: selecting any SAW device (or devices) 10 and inputting channel selection signals from a channel controller 140 to a first multiplexer 121 and a second multiplexer 122; inputting a reference frequency to an input part of the SAW device 10 selected by the first multiplexer 121; transmitting an output frequency from an output part of the selected SAW device 10 to a feedback loop circuit 130 through the second multiplexer 122; comparing the output frequency transmitted to the feedback loop circuit 130 with the reference frequency; and sensing a change, in frequency, for example, with a signal detector 150 to sense a target material.

According to one or more example embodiments of the method, deviations between the SAW devices 10 are effectively minimized, and various target materials contained in the sample can therefore be effectively sensed.

Specifically, for example, when N target materials are contained in the sample, an array including N SAW devices binding to receptors capable of binding to respective target materials is formed.

To examine a reaction of a target material with a first SAW device 10, for example, channel selection signals from the channel controller 140 to the first SAW device 10 are inputted to the first multiplexer 121 and the second multiplexer 122. The reference frequency is inputted to an input part of the first SAW device 10 through the first multiplexer 121, and if the target material binds to the receptor 40, the frequency is altered, and thus an altered frequency is outputted from an output part of the first SAW device 10. The output frequency is transmitted to the feedback loop circuit 130 through the second multiplexer 122. Accordingly, the output frequency is sensed using the detector 150, and compared with the reference frequency to sense the frequency change. The channel selection signals are altered in the channel controller 140, and the procedure described above is repeated, thereby detecting the presence of the N target materials in the one sample.

The reference frequency may be a frequency that corresponds to a condition in which the target material is not present in the sample. The sample may be a biological sample, and thus changes in mass, pressure, density and viscosity of the receptors are sensed by the reaction of the receptor with the target material in the sample.

Hereinafter, the general inventive concept will be described in further detail with reference to specific examples, which are compared each other. It will be noted that these examples described herein are merely provided to illustrate different example embodiments, but the scope of the present invention is not limited to the examples described and shown herein.

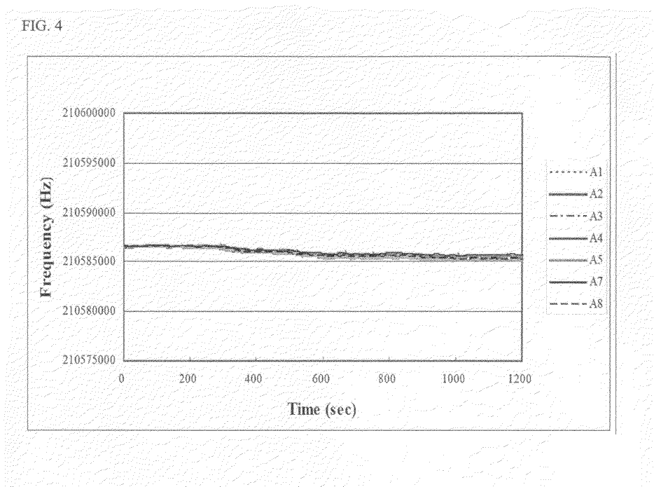

For Example 1, and as shown in FIG. 2, a SAW sensor system was configured such that an array including eight integrated SAW unit devices 10 (A1 through A8 in FIG. 4) was connected to a first and second multiplexers, and one oscillation channel is formed through one feedback loop circuit connected to the first and second multiplexers.

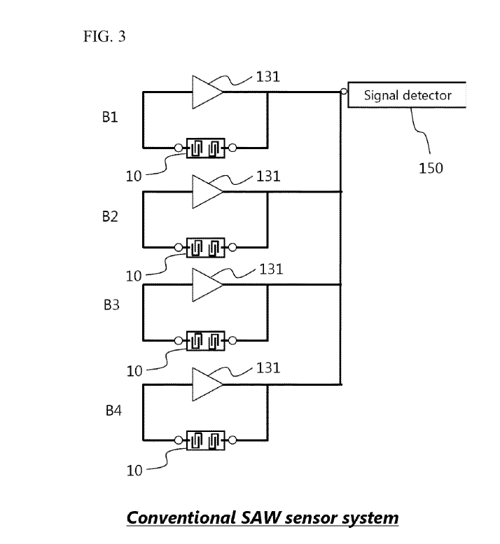

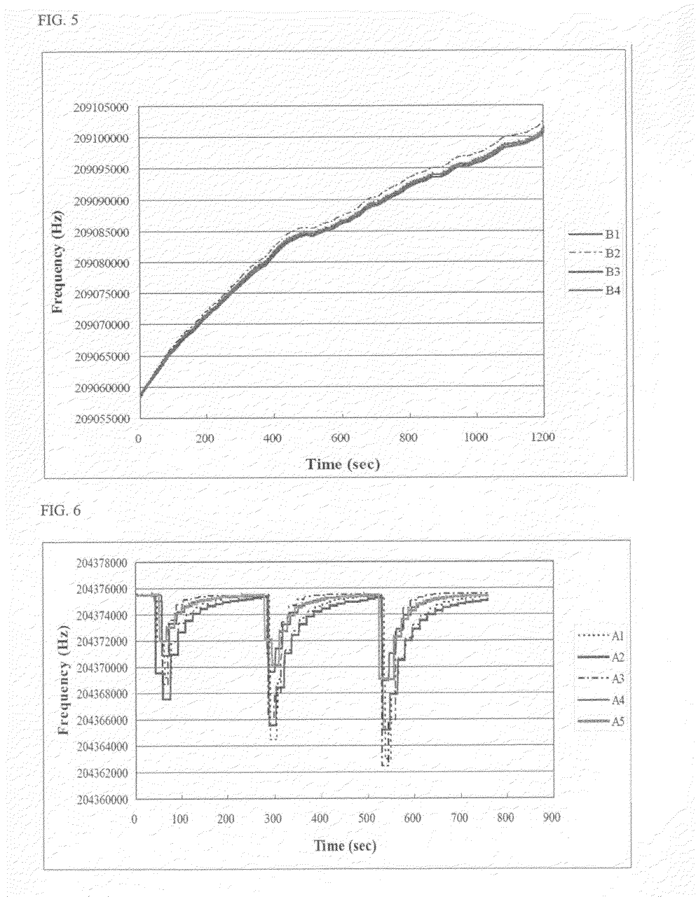

For comparative Example 1, and as shown in FIG. 3, which is a schematic circuit diagram of a conventional SAW sensor system, separate feedback loop circuits corresponding to four SAW unit devices 10 (B1 through B4 in FIGS. 3 and 5) were formed, thereby configuring a SAW sensor system having four oscillation channels.

For Experimental Example 1, a phosphate buffer saline (“PBS”) solution flowed to the SAW sensor systems in Example 1 and Comparative Example 1 in a no-stress state, and signal drifts were measured to check frequency stability. The results are shown in FIGS. 4 and 5, which are graphs of frequency, in Hertz (Hz), versus time, in seconds (sec), showing frequency stabilities of comparative and experimental example embodiments of SAW sensors.

For Example 1, each of the eight SAW unit devices (A1 through A8) was measured every two seconds, and one cycle was 16 seconds. For Comparative Example 1, the four SAW unit devices (B1 through B4) were used to measure the frequency stability. As deviation between the SAW signals decreases, the frequency stability is improved. Thus, as can be seen from Table 1 below and FIG. 4, the results are much better than for a comparative Example 1, conventional SAW sensor system.

TABLE 1

Average Standard Deviation (“stDEV”)

| | Example 1 | Comparative Example 1 |
|---|---|---|
| 5 minutes | 134.4 | 563.59 |
| 10 minutes | 162.6 | 668.431 |
| 20 minutes | 339.4 | 954.096 |

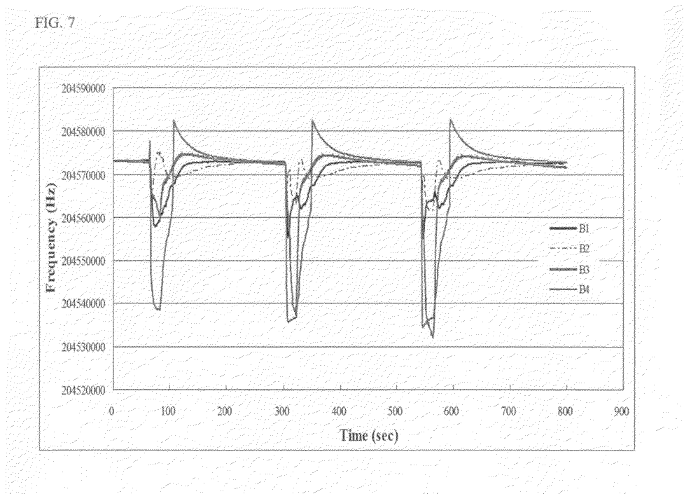

For Experimental Example 2, in the SAW sensor systems in Example 1 (A1 through AS) and Comparative Example 1 (B1 through B4), samples flows of 500, 1000, and 1500 microliters per minute (μl/min) on the PBS solution were provided, and degrees of recovering frequencies changed by a pressure gradient to a normal state were measured. The results of the frequency change caused by a pressure gradient and the recovery to the normal frequency are shown in FIGS. 6 and 7, which are graphs of frequency (in Hz) versus time (in sec) showing frequency stabilities of comparative and experimental example embodiments of SAW sensors. In addition, average standard deviations were calculated, and are shown in Table 2, below.

Referring to FIGS. 6 and 7, as the deviation between the SAW signals decreases, a recovery deviation is smaller. Thus, as shown in Table 2 and FIG. 6, it can be seen that the result of Example 1 is much better than that of Comparative Example 1.

TABLE 2

Average Standard Deviation (stDEV)

| Flow Rate | Example 1 | Comparative Example 1 |
|---|---|---|
| 500 μl/minute | 94.8 | 148.4 |
| 1000 μl/minute | 91.9 | 239.2 |
| 1500 μl/minute | 182.1 | 262.0 |

Thus, in a SAW sensor system according to the example embodiments described herein, two multiplexers are connected to a plurality of SAW devices, and an oscillation circuit is configured using one oscillation channel using a feedback loop circuit, thereby effectively preventing errors, due to deviations between oscillators, and thereby substantially improving sensitivity and reproducibility.

In addition, the system uses an amplification method in the feedback loop circuit, and the sensitivity is thereby further improved, while the plurality of SAW devices can sense a plurality of target materials at one time.

Moreover, when capacitors are disposed between a first multiplexer, a second multiplexer and a SAW device, a direct current applied to the first and second multiplexers cannot be transmitted to the SAW device, and thus a sample solution is not electrolyzed.

The general inventive concept should not be construed as being limited to the example embodiments set forth herein. Rather, these example embodiments are provided so that this disclosure will be thorough and complete and will fully convey the concept of the present invention to those of ordinary skill in the art.

In addition, while the general inventive concept has been particularly shown and described with reference to example embodiments thereof, it will be understood by those of ordinary skill in the art that various changes in form and details may be made therein without departing from the spirit or scope of the present invention as defined by the following claims.

What is claimed is:

1. A surface acoustic wave sensor system, the system comprising:
surface acoustic wave devices;
a first multiplexer connected to input terminals of the surface acoustic wave devices;
a second multiplexer connected to output terminals of the surface acoustic wave devices;
a feedback loop circuit connected between the first multiplexer and the second multiplexer;
a channel controller including a first port, connected to the first multiplexer, and a second port, connected to the second multiplexer, and which applies a channel selection signal to at least one of the first multiplexer and the second multiplexer; and
a detector connected to the feedback loop circuit and which senses an electrical signal from the second multiplexer.

2. The system of claim 1, wherein the channel controller applies the channel selection signal to the first multiplexer and the second multiplexer through the first port and the second port, respectively.

3. The system of claim 1, wherein the feedback loop circuit selectively transmits electrical oscillation signals to the surface acoustic wave devices through the first multiplexer and electrical signals generated from the surface acoustic wave devices to the first multiplexer through the second multiplexer.

4. The system of claim 1, further comprising capacitors connected between the input terminals of the surface acoustic wave devices and the first multiplexer, and between the output terminals of the surface acoustic wave devices and the second multiplexer.

5. The system of claim 1, wherein the feedback loop circuit includes an amplifier which amplifies the electrical signal from the second multiplexer.

6. The system of claim 1, wherein the channel controller and the detector are implemented in one integrated circuit.

7. The system of claim 1, wherein the surface acoustic wave devices are disposed on a single base plate.

8. The system of claim 1, wherein each of the surface acoustic wave devices comprises:
a pair of inter-digital transducer electrodes disposed on a piezoelectric substrate; and
a receptor disposed on the piezoelectric substrate to cover at least a portion of the corresponding pair of inter-digital transducer electrodes,
wherein a target material is bound to the receptor.

9. A method of sensing a target material from a sample using a surface acoustic wave sensor system including surface acoustic wave devices, a first multiplexer connected to input terminals of the surface acoustic wave devices, a second multiplexer connected to output terminals of the surface acoustic wave devices, a feedback loop circuit connected between the first multiplexer and the second multiplexer, a channel controller including a first port, connected to the first multiplexer, and a second port, connected to the second multiplexer, and which applies a channel selection signal to at least one of the first multiplexer and the second multiplexer, and a detector connected to the feedback loop circuit and which senses an electrical signal from the second multiplexer, the method comprising:
selecting at least one of the surface acoustic wave devices and inputting channel selection signals from the channel controller to the first multiplexer and the second multiplexer;
inputting a reference frequency to the input terminal of the surface acoustic wave device selected by the first multiplexer;
transmitting an output frequency from an output terminal of the selected surface acoustic wave device to the feedback loop circuit through the second multiplexer;
comparing the output frequency transmitted to the feedback loop circuit with the reference frequency; and
sensing a change with the detector to sense a target material.

10. The method of claim 9, wherein the reference frequency is a frequency when the target material is not present.

11. The method of claim 9, wherein the sample is a biological sample.

12. The method of claim 9, wherein the channel controller applies the channel selection signal to the first multiplexer and the second multiplexer through the first port and the second port, respectively.

13. The method of claim 9, wherein the surface acoustic wave sensor system further includes capacitors connected between the input terminals of the surface acoustic wave devices and the first multiplexer, and between the output terminals of the surface acoustic wave devices and the second multiplexer.

14. The method of claim 9, wherein the feedback loop circuit includes an amplifier which amplifies the electrical signal from the second multiplexer.

15. The method of claim 9, wherein the channel controller and the detector are implemented in one integrated circuit.

16. The method of claim 9, wherein the surface acoustic wave devices are disposed on a single base plate.
